(19) United States
(12) Patent Application Publication
(10) Pub. No.: US 2006/0014556 A1
(43) Pub. Date: Jan. 19, 2006

(54) Method and apparatus for processing call in PTT over cellular (PoC) system

(75) Inventors: Sung-Jin Park, Suwon-si (KR); Ki-Ho Jung, Kwachon-si (KR); Sang-Kyung Sung, Seoul (KR)

Correspondence Address: DILWORTH & BARRESE, LLP, 333 EARLE OVINGTON BLVD., UNIONDALE, NY, 11553, US

(73) Assignee: SAMSUNG ELECTROICS CO., LTD., Suwon-si (KR)

(21) Appl. No.: 11/182,271

(22) Filed: Jul. 15, 2005

(30) Foreign Application Priority Data
Jul. 16, 2004 (KR) 10-2004-0055779

(51) Int. Cl. H04B 7/00

(52) U.S. Cl. 455/518; 455/517; 455/519; 455/520

(57) ABSTRACT

A push to talk (PTT) system. Where when there is a call connection request to any terminal in a PTT system with a pre-established session, a query message is transmitted to a PTT terminal receiving the call connection request in order to determine to accept a call request, and a determination is made as to whether to connect the call based on a response message, this preventing a waste of resources and time due to unnecessary session establishment.

### PRIORITY

This application claims all benefits accruing under 35 U.S.C. §119 from an application entitled “METHOD AND APPARATUS FOR PROCESSING CALL IN PTT OVER CELLULAR (PoC) SYSTEM,” filed in the Korean Intellectual Property Office on Jul. 16, 2004 and there duly allocated Serial No. 2004-55779, the contents of which are herein incorporated by reference.

### BACKGROUND OF THE INVENTION

1. Field of the Invention

The present invention relates to a method and apparatus for processing a call in a push to talk (PTT) system, and more particularly, to a method and apparatus for processing a call to establish a call connection with a PTT service terminal engaged in a pre-established session.

2. Description of the Related Art

A push to talk (PTT) system provides a PTT service that is an instant service, akin to a walkie-talkie service, to a PTT service subscriber using a PTT terminal. The PTT service is literally a service by which the PTT service subscriber is able to immediately talk to another subscriber by pushing a talk button, i.e. an input means (“switch”), that enables the PTT terminal to perform the PTT service. The PTT service is capable of providing a relatively fast communication service. Further, a group service in the PTT service allows PTT service subscribers in the group to listen to a talk of one PTT service subscriber using their PTT terminals, overcoming a limitation of 1-to-1 communication by typical telephones. The PTT service subscriber can select one of an instant personal talk service provided to one PTT service subscriber, adhoc group talk and instant group talk services provided to specific multiple PTT service subscribers, and a chat service provided to unspecific multiple PTT service subscribers.

When the PTT subscriber pushes a switch on the PTT terminal to talk, the PTT terminal transmits a PTT service request to a network. The network either refuses to accept the request from the PTT terminal or assigns resources for supporting the service, based on predetermined criteria such as resource availability, a requesting user's priority, and the like. When a session is established to provide the requested service from the PTT terminal, the PTT subscriber requesting the PTT service is then able to talk, and other PTT subscribers are then able to listen through the session. When the PTT subscriber releases the PTT connection, the PTT terminal transmits a release message to the network, and the network receiving the message releases the resources. Thus, resources are utilized only for an actual voice transaction or voice item.

Since the PTT system is able to provide a fast communication service to PTT subscribers as described above, it is necessary to have a short call setup time. It is required to provide the PTT service to the PTT subscriber within a short time after the call, i.e. a voice item, is initiated. That is, session establishment for the PTT call connection should be completed within a short time.

In the PTT system, a pre-established session is used to reduce a time to establish a session upon the call connection. The pre-established session is established between a PTT server and a PTT terminal to store in advance information required for session establishment. That is, the pre-established session process includes a mechanism in which negotiation proceeds to obtain media parameters, such as Internet protocol (IP) addresses, ports and a CODEC used to communicate media and a talk burst control message between the PTT terminal and the home PTT server. A system with the pre-established session is allowed to directly establish the session without performing exchange negotiation when the session for PTT call information should be established, which reduces a time from a session establishment request to session completion.

Upon receipt of a message requesting to establish a session from any PTT terminal, the PTT system sends a message to accept the request without exchanging a message with a correspondent terminal when the PTT terminal to receive the message has the pre-established session. In a manual answer mode, when a PTT over cellular (PoC) client B 100-B receives a PoC call, it is asked to a PoC user whether to accept the PoC call.

A session establishment process in a manual answer mode on a system with a pre-established session will be described with reference to the accompanying drawings.

FIG. 4 shows a conventional session establishment process in a manual answer mode on a PoC system with a pre-established session.

In FIG. 4, when a PoC client B 100-B receives an INVITE message 501, 503, 505 requesting to establish a session for a PoC call requested by a PoC client A 100-A, the PoC client B 100-B automatically transmits an OK message 507, 509, 511 to a PoC server A 130-A in a manual answer mode. Accordingly, a PoC session 513 is initiated between the PoC client A 100-A and the PoC client B 100-B and a media connection is created irrespective of the intention of the PoC client B 100-B. In the session, the PoC server A 130-A notifies the PoC client B 100-B that the PoC client A 100-A has a floor, using floor taken messages 515 and 517.

After the session is established, the PoC client B 100-B transmits a floor taken reply message 519, including an indication whether to accept the PoC call, to the PoC server B 130-B.

When the PoC client B 100-B accepts the PoC call, floor determination is made based on a floor taken reply message 521. When the PoC client B 100-B does not accept the PoC call, the PoC server B 130-B has to notify the PoC server A 130-A that the PoC client B 100-B does not accept the call using the floor taken relay message 521, and release the media connection, previously established through the INVITE message, using a BYE message from the PoC client B 100-B.

In the foregoing process, when the PoC system with the pre-established session sets a manual answer mode, there is no problem only if the PoC client B 100-B receiving a PoC call connection request accepts the PoC call.

The PoC client A acquires the floor through processes 523. The PoC client A then forwards voice to the PoC server A 525. The voice from the PoC server A is delivered to the PoC server B 527 and then to the PoC client B 529. At the processes 525 to 529, the voice may be delivered through a simple voice over Internet protocol (VoIP).

However, when the PoC client B 100-B does not accept the PoC call, radio resources are wasted because floor status information is delivered to the PoC client B 100-B after the media connection is established, and then it is determined whether to accept or deny the PoC call by the PoC client B 100-B has. Further, there is a need for another process to release the established media connection.

In a manual answer mode on a conventional PoC system with a pre-established session, when a session between two PoC clients is established, the PoC client receiving a PoC call request is forced to determine if the PoC call is accepted. Even when the PoC client does not accept the PoC call, the processes of establishing a media connection, receiving floor status information, releasing the established media connection, and the like are performed. Accordingly, unnecessary resources and time are wasted.

### SUMMARY OF THE INVENTION

Accordingly, it is an object of the present invention to provide a method and apparatus for processing a call in a push to talk (PTT) system capable of preventing unnecessary session establishment with respect to a PTT client having a pre-established session.

According to an aspect of the present invention, there is provided a method for processing a call in a PTT over cellular (PoC) network, including the steps of pre-establishing a session between a PoC client and a PoC server; receiving a call connection request message by the PoC server with the pre-established session; transmitting, by the PoC server, a query message to the PoC client to query if the PoC client accepts the call connection; and transmitting, by the PoC client, a response message to the PoC server in response to the query message.

According to another aspect of the present invention, there is provided a system for processing a call in a PTT over cellular (PoC) network, including a sending PoC system having a PoC server that transmits a PoC call connection request message; a receiving PoC server that receives the call connection request message from the sending PoC system and generates a query message to query if the call connection request is accepted; and a receiving PoC client that makes a pre-established session with the receiving PoC server, receives the query message from the receiving PoC server with the pre-established session, and transmits a response message to the query message to the receiving PoC server.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of a typical push to talk (PTT) system;

FIG. 2 is a block diagram of a PoC server that is one component of the PTT system shown in FIG. 1;

FIG. 3 illustrates a process of establishing a pre-established session in a PTT system;

FIG. 4 illustrates conventional call processing in manual answer mode in a PTT system with a pre-established session; and

FIG. 5 illustrates call processing in manual answer mode in a PTT system with a pre-established session according to the present invention.

### DETAILED DESCRIPTION OF THE PREFERRED EMBODIMENTS

The present invention described below suggests a method for preventing performance of unnecessary procedures in which a query message is transmitted to a PTT terminal receiving a session establishment request in order to determine whether to accept a session request, and determination is made as to whether to establish a session based on a response message.

A PTT service network for providing a PTT service to subscribers will be described with reference to the accompanying drawings.

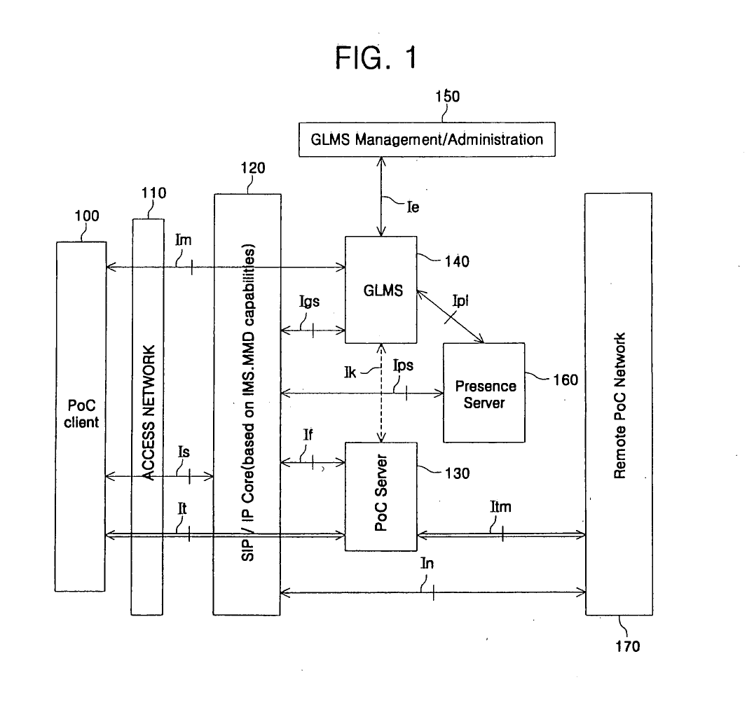

FIG. 1 is a diagram illustrating a configuration of a PTT service network. FIG. 1 specially shows a PTT over cellular (PoC) system that implements a PTT service based on a cellular network. Although the present invention will be described by way of example in connection with a PoC system of FIG. 1, it is intended to easily illustrate the present invention and the present invention may be applied to all PTT systems as well as the PoC system.

As shown in FIG. 1, the PoC system is composed of a PTT over cellular (PoC) client 100, an access network 110, a core session initiation protocol/Internet protocol (SIP/IP) core 120, a PoC server 130, a group and list management server (GLMS) 140, GLMS management/authentication unit 150, a presence server 160, and a remote PoC network 170.

The PoC client 100 is a PoC terminal for providing a PoC service to a PoC service subscriber and performs access to the PoC service. The PoC client 100 has as its primary functions initiating a PoC session, participating an existing session and terminating the session with respect to PoC service subscribers. In addition, the PoC client 100 may create and deliver a talk burst, support an instant personal alert, provide authentication upon accessing the PoC service, and the like. The PoC service subscriber uses the PoC client 100 to receive the PoC service. Accordingly, a mention of the PoC service subscriber will be omitted except when required. To receive the PoC service, the PoC client 100 is required to register its address in a serving-call service control function (S-CSCF; not shown) and a home subscriber server (HSS; not shown) constituting the SIP/IP core network, and acquire authentication.

The access network 110 refers to an access network on a conventional cellular network. Examples of the access network may include a base station transceiver system (BTS) and a base station controller (BSC) in the IS-95 and CDMA 2000 based systems. The PoC client 100 is allowed to access the IP based PoC network via the access network.

The SIP/IP core 120 performs message delivery, a registration of the PoC client 100 with the PoC service network, and the like. The SIP/IP core 120 is also termed a proxy. When the PoC client 100 completes address registration and authentication with respect to the S-CSCF and the HSS, the SIP/IP core 120 informs the PoC server 130 of all of the procedures to indicate that the PoC client 100 connects to the system. The SIP/IP core 120 parses the addresses of the respective PoC clients 100 while establishing the PoC session. That is, when the SIP/IP core 120 receives information about a group address from the PoC server 130, the SIP/IP core 120 recognizes where the PoC server 130 that is actually serving the PoC client 100 or an actual physical address of the PoC client 100, and establishes the SIP session.

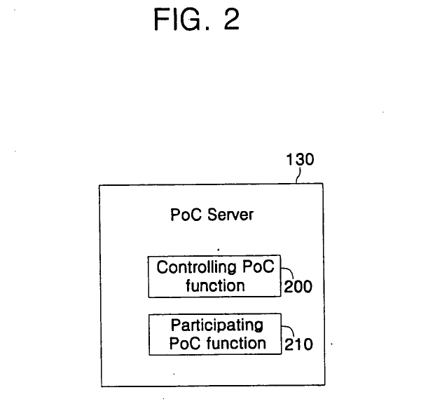

The PoC server 130 receives an SIP message from the SIP/IP core 120 and cooperates with the GLMS 140 to perform the call processing corresponding to the service. The PoC server 130 will be described below in detail with reference to FIG. 2.

The group and list management server (GLMS) 140 produces, modifies and deletes information about a group or its members to provide the PoC service. The PoC service subscriber may utilize its PoC client 100 to enter the information about the group or the members into the GLMS 140, or recognize information about PoC clients 100 that the PoC service subscriber can make a call, based on a received list of persons or groups from the GLMS 140. The PoC service subscriber can produce, modify and manage the group and the members in GLMS 140 via a communication network such as the Internet, an intranet, or the like, that a PoC service provider can trust, without utilizing the PoC client 100.

The GLMS management/authentication unit 150 supports the functions of the GLMS 140.

The presence server 160 stores current states of the respective PoC clients 100 (e.g., reachable, busy, Do-Not-Disturb, and the like), and provides state information of the PoC client 100, if necessary. That is, the presence server 160 stores state information about whether the PoC client 100 is on-line and about a position of the PoC client 100, registers/reserves a current position of the PoC client 100 in the on-line state, and provides the information to the PoC service subscribers that need the information so that a prompt communication service is enabled.

Similarly, the remote PoC network 170 includes the PoC client, access network, SIP/IP core, PoC server, GLMS server, GLMS management/authentication unit, presence server from the PoC client 100 to the presence server 160 as described above.

The components of the PoC system may be connected to one another via Is, If, In, Im, Ik, Ipl, Ips, Ie, It and Itn interfaces, as shown in FIG. 1. “Is” is an interface used to perform session signaling between the PoC client 100 and the SIP/IP core 120. “If” is an interface used to perform session signaling between the SIP/IP core 120 and the PoC server 130. “In” is an interface used to perform session signaling between a sending SIP/IP core and a receiving SIP/IP core. “Im” is an interface used to manage a group for PoC clients. “Ik” is an interface used to is manage a group for the PoC server 130. “Ipl” and “Ips” are interfaces used to provide access information about the PoC client 100 to the GLMS 140 and the SIP/IP core 120. Ie is an interface used to connect between the GLMS management/authentication unit 150 and the GLMS. Finally, “It” and “Itn” are interfaces used for floor control and media processing.

Among these interfaces, a session is established via the Is, If and In interfaces to provide the PoC service. PoC service data transmission and PoC service control are performed via a session established by the It and Itn interfaces. The PoC service session is established using a session initiation protocol (SIP). The SIP is a protocol used for signaling that is related to a call setup, a call release and other additional services. The SIP is text based application level protocol and has been recently employed in a number of systems because of its simple structure and excellent extensibility compared to the conventional protocols. The SIP is a signal protocol used to establish the session. The SIP can be used to provide for video conference, multimedia, on-line game connection and the like, as well as Internet telephony. Request for Comment (RFC) 2543 and its subsequent versions have been adopted as a standard RFC and are now updated into RFC 3261. Messages described herein will be presumed to be SIP messages unless mentioned separately.

FIG. 2 is a functional block diagram of the PoC server. As shown in FIG. 2, the PoC server 130 may include a controlling PoC function 200 and a participating PoC function 210. The controlling PoC function 200 serves to manage the PoC session. The controlling PoC function 200 receives a request for rights of PoC clients 100 to talk (hereinafter, referred to as “floors”), orders the floors of the respective PoC clients 100, and provides the floors. Further, the controlling PoC function 200 serves to distribute a talk of one client to all other clients that participate in the group call. Further, the controlling PoC function 200 provides information about the PoC clients 100 that participate in the group call.

The participating PoC function 210 manages sessions associated with the respective PoC clients 100. The participating PoC function 210 relays between the PoC client 100 and the controlling PoC function 200 when the PoC client 100 requests the controlling PoC function 200 to provide a floor or the controlling PoC function 200 provides the floor to the PoC client 100. Further, the participating PoC function 210 relays media between the controlling PoC function 200 and the PoC client 100, and when they use a different CODEC, performs a transcoding operation. Further, when one talk is in session and another talk occurs in and session, the participating PoC function 210 filters one of the talks depending on a selection by the PoC client 100. The PoC client 100 may connect to a plurality of different controlling PoC functions 200 through the single participating PoC function 210.

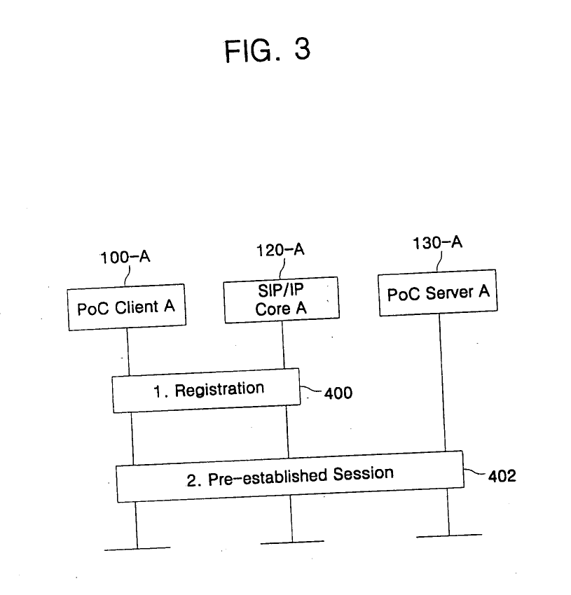

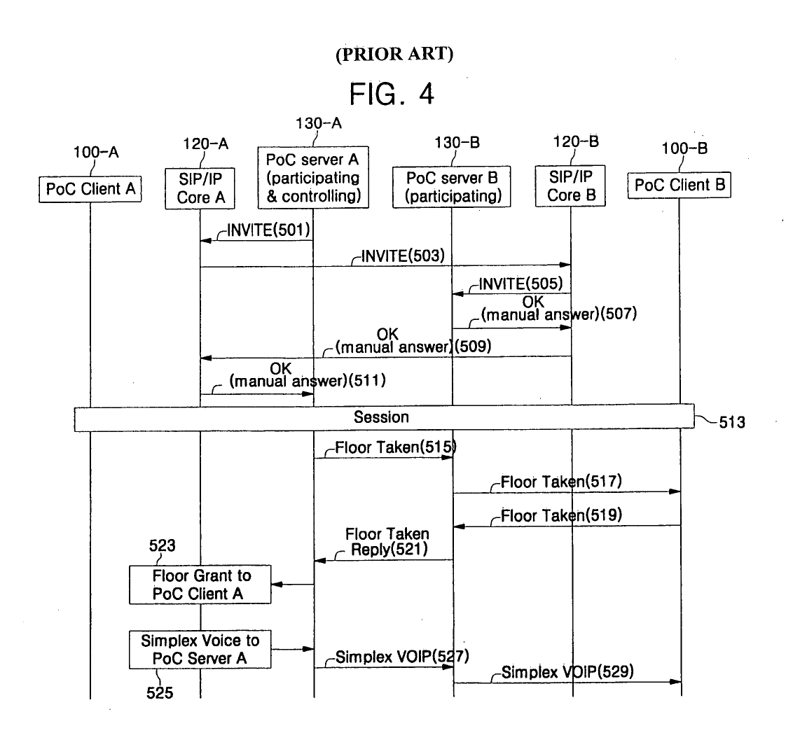

The present invention is applied to a PoC system with the pre-established session as shown in FIG. 4. FIG. 3 shows a process of establishing a pre-established session in a PTT system. As shown in FIG. 3, a pre-established session establishment process 402 may be performed when a process 400 of registering and authenticating the PoC client A 100-A with the SIP/IP core A 120-A is completed. Upon performing the re-established session establishment process 402, a mechanism for negotiating media parameters such as Internet protocol (IP) addresses, ports and CODECs used to transmit media and a talk burst control message is performed between the PoC client A 100-A and the home PoC server A 130-A. The use of the pre-established session eliminates a re-negotiation process between the PoC client A 100-A and the PoC server A 130-A upon the PoC call request.

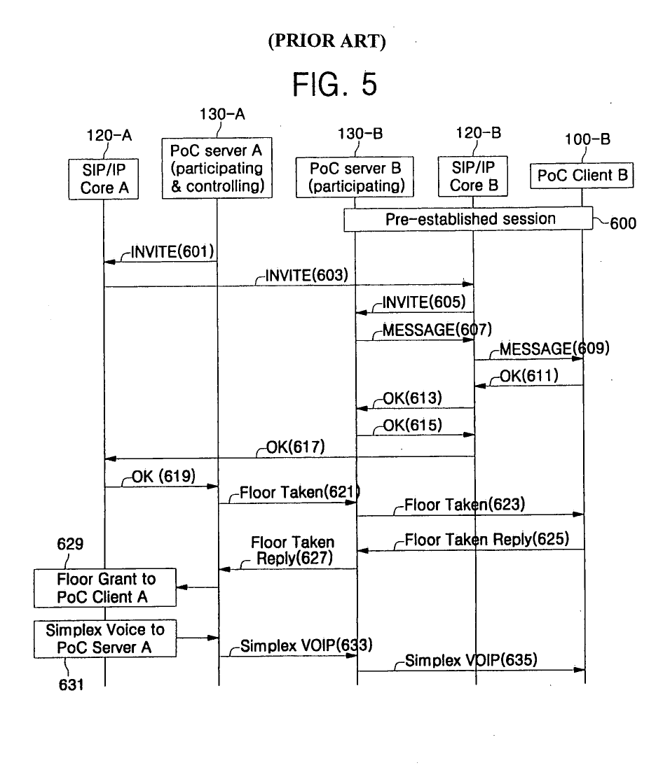

The method according to the present invention will be now described with reference to FIG. 5, in which the PoC system with the pre-established session is allowed to determine if a PoC client receiving a session establishment request accepts the requested PoC call.

FIG. 5 illustrates call processing in manual answer mode in a PoC system with a pre-established session according to the present invention. As shown in FIG. 5, the PoC system with the pre-established session 600 transmits an INVITE message to the PoC server B 130-B in response to a PoC call request by the PoC client A 100-A (601, 603 and 605).

The PoC server B 130-B, which receives the INVITE message responsive to the PoC call request, transmits a query message “MESSAGE” 607-609 to query whether the call is accepted, to the PoC client B 100-B. This query message is transmitted to the PoC client B 100-B through a transmission process from the PoC server 130-B to the SIP/IP core B 120-B (607) and a transmission process from the SIP/IP core B 120-B to the PoC client B 100-B (609).

The query messages 607 and 609 contain information that indicates the PoC client 100 (i.e. PoC client A 100-A and PoC client B 100-B) requesting the PoC call. The PoC server B 130-B performs its check using the query messages 607 and 609 to determine if the PoC client B 100-B accepts the PoC call.

When the PoC client B 100-B, which receives the query message, desires to accept the PoC call, the PoC client B 100-B transmits an OK message to the PoC server B 130-B PoC that includes information notifying that the call is accepted (611 and 613). The OK message may include both information indicating that the query message is received and information indicating that the PoC call is accepted.

Upon receipt of the OK message responsive to the query message from the PoC client B 100-B, the server B 130-B transmits the received OK message from the PoC server A 130-A responsive to the INVITE message to the PoC server A 130-A (615, 617, 619). That is, the query message acts as a trigger event of the response signal to the INVITE message. The OK message transmission from the PoC server B 130-B to the PoC server A 130-A is also performed via the SIP/IP cores 120. The subsequent call establishment processes 621 to 635 are the same as the processes 515 to 529 shown in FIG. 4. A description of subsequent call setup related processes will be omitted.

When the PoC client B 100-B wants to not accept the PoC call, the PoC client B 100-B transmits an OK message to the PoC server B 130-B that contains information indicating that the PoC call is not accepted (611). Examples of the OK message may include No. 406: Not Acceptable and No. 486: Busy Here of an SIP response message, and the like. The PoC server B 130-B, which receives this response message from the PoC client B 100-B, transmits a response message indicating Not Acceptable or Busy to the PoC server A 130-A, which acts as the controlling PoC function 200 (615). In this case, the PoC call ends without generating a media connection.

According to the present invention, only when the PoC client B 100-B receiving the PoC call request accepts the PoC call, session establishment and media connection generation are made, preventing wastes of resources by unnecessary session establishment and media connection generation, and wastes of a time due to performance of these procedures.

As described above, the embodiments using the PoC system are only intended to assist in understanding the present invention, and the present invention may be applied to all PTT systems, as well as the PoC system.

The present invention prevents a PTT system with a pre-established session to perform unnecessary processes. Accordingly, it is possible to reduce the number of session establishment processes and shorten a session establishment time through a pre-established session, and to reduce usage resources and time by virtue of the additional process reduction.

While the present invention has been described with reference to exemplary embodiments thereof, it will be understood by those skilled in the art that various changes in form and detail may be made therein without departing from the scope of the present invention as defined by the following claims.

What is claimed is:

1. A method for processing a call in a push to talk (PTT) over cellular (PoC) network, the method comprising the steps of:
pre-establishing a session between a PoC client and a PoC server;
receiving a call connection request message by the PoC server with the pre-established session;
transmitting, by the PoC server, a query message to the PoC client to determine if the PoC client accepts the call connection; and
transmitting, by the PoC client, a response message to the PoC server in response to the query message.

2. The method according to claim 1, wherein the query message includes information related to a client requesting the call connection.

3. The method according to claim 2, further comprising a step of establishing a session with the client requesting the call connection when the response message indicates that the call connection request is accepted.

4. The method according to claim 2, wherein when the PoC client refuses to accept the call connection request, the response message includes information that the PoC call is not accepted.

5. The method according to claim 1, wherein the call connection request message, the query message and the response message are session initiation protocol (SIP) messages.

6. A system for processing a call in a push to talk (PTT) over cellular (PoC) network, the system comprising:
a sending PoC system having a PoC server that transmits a PoC call connection request message;
a receiving PoC server that receives the call connection request message from the sending PoC system and generates a query message to determine if the call connection request is accepted; and
a receiving PoC client that establishes a session with the receiving PoC server, receives the query message from the receiving PoC server with the established session, and transmits a response message to the query message to the receiving PoC server.

7. The system according to claim 6, wherein the call connection request message and the query message includes information related to a client requesting the call connection.

8. The system according to claim 7, wherein the call connection request message, the query message and the response message are SIP messages.

9. A push to talk (PTT) over cellular (PoC) client for performing a call connection on a PoC network, wherein the PoC client establishes a session with a receiving PoC server and the PoC client receives a query message to a call connection request message from the receiving PoC server, and transmits a response message indicating whether to accept the call connection.

10. The PoC client according to claim 9, wherein the call connection request message and the query message include information about a client requesting the call connection.

11. A method for performing call processing in a push to talk (PTT) over cellular (PoC) client on a PoC network, the method comprising the steps of:
pre-establishing a session between the PoC client and a PoC server;
receiving a query message related to a call connection from the PoC server with the pre-established session; and
transmitting a response message indicating whether to accept the call connection.

12. The method according to claim 11, wherein the query message includes information about a client requesting the call connection.
